(19) United States
(12) Patent Application Publication
(10) Pub. No.: US 2011/0234761 A1
(43) Pub. Date: Sep. 29, 2011

(54) THREE-DIMENSIONAL OBJECT EMERGENCE DETECTION DEVICE

(76) Inventors: Ryo Yumiba, Hitachi (JP); Masahiro Kiyohara, Hitachi (JP); Kota Irie, Hitachinaka (JP); Tatsuhiko Monji, Hitachinaka (JP)

(21) Appl. No.: 13/133,215

(22) PCT Filed: Dec. 7, 2009
(86) PCT No.: PCT/JP2009/070457

§ 371 Date: Jun. 7, 2011

(30) Foreign Application Priority Data
Dec. 8, 2008 (JP) 2008-312642

(51) Int. Cl. H04N 13/02

(52) U.S. Cl. 348/46; 348/E13.074

(57) ABSTRACT

Provided is a three-dimensional object emergence detecting device capable of detecting the emergence of a three-dimensional object rapidly and correctly at low costs.

Based on a bird's-eye view image 30 taken by a camera 21 mounted in a vehicle 20, the three-dimensional object emergence detecting device detects the emergence of a three-dimensional object 22 in the vicinity of the vehicle. From the bird's-eye view image 30, the three-dimensional object emergence detecting device extracts orthogonal-direction characteristic components 46 and 47, which are on the bird's-eye view image 30 and has directions 36 and 37 orthogonal to a view direction 33 of the camera 21, and based on amounts of the extracted orthogonal-direction characteristic components 46 and 47, detects the emergence of the three-dimensional object 22. This prevents from erroneously detecting incidental changes in the image, such as sway of sunshine or movement of a shadow, as the emergence of the three-dimensional object.

### TECHNICAL FIELD

The present invention relates to a three-dimensional object emergence detecting device for detecting the emergence of a three-dimensional object in the vicinity of a vehicle based on an image from an in-vehicle camera.

### BACKGROUND ART

A device for supporting driving, in which an in-vehicle camera is placed in a backward-looking manner in a rear trunk part and the like of a vehicle, and a taken image backward of the vehicle obtained from this in-vehicle camera is shown to a driver, is beginning to become popular. As such in-vehicle camera, normally, a wide-angle camera capable of imaging a wide range is used, and is configured so as to display the taken image having the wide range on a small monitor screen.

However, in the wide-angle camera, lens distortion is large, so that straight lines are imaged as curve lines. Accordingly, an image displayed on the monitor screen becomes the image which is hard to be seen. Therefore, conventionally, as described in Patent Document 1, the lens distortion is eliminated from a taken image of the wide-angle camera, and the taken image is converted into the image in which the straight lines can be seen as the straight lines, and such image is displayed on the monitor screen.

A driver finds a burden against visually observing such camera that captures circumference of a vehicle at all times and confirming the safety. Thus, there are conventionally disclosed techniques for detecting, by means of image processing, a three-dimensional object such as a person in danger of collision against the vehicle based on pictures from a camera (for example, see Patent Document 1).

Additionally, there are conventionally disclosed techniques that during the time when a vehicle travels at low speed, based on motion parallax at the time of performing bird's-eye view conversion when having performed viewpoint conversion on images photographed at two times, the images are separated into an area of an earth surface and an area of the three-dimensional object, thereby detecting a three-dimensional object (for example, see Patent Document 2).

Further, there are disclosed techniques for detecting a three-dimensional object around a vehicle based on stereoscopic views of cameras both of which are mounted side by side (for example, see Patent Document 3). Additionally, there are disclosed techniques for an image when a vehicle is stopped and an ignition is turned off is compared with an image when the ignition is turned on in order to start the vehicle, thereby detecting changes around the vehicle during the time from when the vehicle is stopped to when the vehicle is started, and alarming a driver (for example, see Patent Document 4).
Patent Document 1: JP Patent No. 3300334
Patent Document 2: JP Patent Publication (Kokai) No. 2008-85710 A
Patent Document 3: JP Patent Publication (Kokai) No. 2006-339960 A
Patent Document 4: JP Patent Publication (Kokai) No. 2004-221871 A
Non-Patent Document 1: T. Kurita, N. Otsu, and T. Sato, “A face recognition method using higher order local autocorrelation and multivariate analysis,” Proc. of Int. Conf. on Pattern Recognition, August 30-September 3, The Hague, Vol. II, pp. 2 13-2 16, 1992.
Non-Patent Document 2: K. Levi and Y. Weiss, “Learning Object Detection from a Small Number of Examples: the Importance of Good Features.,” Proc. CVPR, vol. 2, pp. 53-60, 2004.

### DISCLOSURE OF THE INVENTION

### Problems to be Solved by the Invention

However, the technique of Patent Document 2 has a first problem that due to the use of motion parallax, such technique cannot be adopted during the time when a vehicle is stopped. Additionally, in the case where a three-dimensional object is present in the close vicinity of the vehicle, there is a possibility that an alarm would not make it in time during the time from when the vehicle starts to move to when such vehicle collides against the three-dimensional object. The technique of Patent Document 3 requires two cameras both of which face the same direction for stereoscopic viewing, resulting in high costs.

The technique of Patent Document 4 is applicable even with a single camera per one angle of view in a state where a vehicle is stopped. However, such technique compares two images when an ignition is turned off and the ignition is turned on based on strength in unit of a local such as a pixel or an edge, whereby it is not possible to discriminate a case where a three-dimensional object has emerged around the vehicle from a case where the three-dimensional object is left from surroundings of the vehicle during the time from when the ignition is turned off and to when the ignition is turned on. Additionally, under an outdoor environment, fluctuations in the image other than the emergence of the three-dimensional object, such as a sway of sunshine or movement of a shadow, locally occur in a frequent manner, and thus, there is a possibility that many false alarms would be output.

The present invention has been made in view of the foregoing, and has an object to provide a three-dimensional object emergence detecting device capable of detecting emergency of a three-dimensional object rapidly and correctly at low costs.

### Means for Solving the Problems

A three-dimensional object emergence detecting device of the present invention for solving the above-mentioned problems has features in that, in the three-dimensional object emergence detecting device for detecting the emergence of a three-dimensional object in the vicinity of a vehicle based on a bird's-eye view image taken by a camera mounted in the vehicle, orthogonal-direction characteristic components, each of which is on the bird's-eye view image and has a direction nearly orthogonal to an view direction of the camera, are extracted from the bird's-eye view image, and based on the extracted orthogonal-direction characteristic components, the emergence of the three-dimensional object is detected.

### Effects of the Invention

According to the present invention, orthogonal-direction characteristic components, each of which is on a bird's-eye view image and has a direction nearly orthogonal to an view direction of an in-vehicle camera, are extracted from the bird's-eye view image, and based on the extracted orthogonal-direction characteristic components, the emergence of a three-dimensional object is detected, thereby enabling to prevent erroneous detection of contingent changes in an image, such as sway of sunshine or movement of a shadow, as the emergence of the three-dimensional object.

The present description incorporates the contents described in the description and/or drawings of JP Patent Application No. 2008-312642 on which the priority of the present application is based.

### BRIEF DESCRIPTION OF THE DRAWINGS

FIG. 1 is a functional block diagram of a three-dimensional object emergence detecting device in Embodiment 1.

FIG. 2 is a diagram showing a state in which a bird's-eye view image obtaining means obtains a bird's-eye view image.

FIG. 3 is a diagram showing a calculation method of a light-dark gradient directional angle by means of a directional characteristic component extracting means.

FIG. 4 is a diagram showing timing which an operation controlling means obtains.

FIG. 5 is a flowchart showing processing by means of a three-dimensional object detecting means of Embodiment 1.

FIG. 6 is a diagram explaining a detection area by means of the three-dimensional object detecting means.

FIG. 7 is a diagram explaining distribution characteristics of directional characteristic components in a detection area.

FIG. 8 is a diagram showing one example of a screen output of an alarm means 8.

FIG. 9 is a functional block diagram of the three-dimensional object emergence detecting device in Embodiment 2.

FIG. 10 is a diagram showing one example of a bird's-eye view image obtained by the bird's-eye view image obtaining means.

FIG. 11 is a flowchart showing processing of a three-dimensional object detecting means of Embodiment 2.

FIG. 12 is a functional block diagram of the three-dimensional object emergence detecting device in Embodiment 3.

FIG. 13 is a diagram showing one example of a bird's-eye view image obtained by the bird's-eye view image obtaining means.

FIG. 14 is a flowchart showing processing of a three-dimensional object detecting means of Embodiment 3.

FIG. 15 is a diagram explaining processing of Step S9.

FIG. 16 is a diagram showing another example of the screen output of the alarm means 8.

FIG. 17 is a diagram supplementarily explaining the processing of Step S9.

FIG. 18 is a diagram explaining changes in drawings of broken lines in response to a distance between a three-dimensional object and a camera.

### DESCRIPTION OF SYMBOLS

1 . . . Bird's-eye view image obtaining means, 2 . . . Directional characteristic component extracting means, 3 . . . Vehicle signal obtaining means, 4 . . . Operation controlling means, 5 . . . Memory means, 6 . . . Three-dimensional object detecting means, 7 . . . Camera geometric record, 8 . . . Alarm means, 10 . . . Image detecting means, 12 . . . Sensor, 20 . . . Vehicle, 21 . . . Camera, 22 . . . Three-dimensional object, 30 . . . Bird's-eye view image, 31 . . . Viewpoint, 32 . . . Form 33 . . . View direction, 40 . . . Coordinate grid, 46, 47 . . . Orthogonal-direction characteristic components, 50 . . . Interval, 51 . . . Start point, 52 . . . End point

### BEST MODE FOR CARRYING OUT THE INVENTION

Hereafter, specific embodiments according to the present invention will be described with reference to the drawings. It is to be noted that the present embodiments will be described citing an automobile as one example of a vehicle, however, the “vehicle” according to the invention is by no means limited to the automobile, and includes all types of movable bodies that travel on an earth surface.

### Embodiment 1

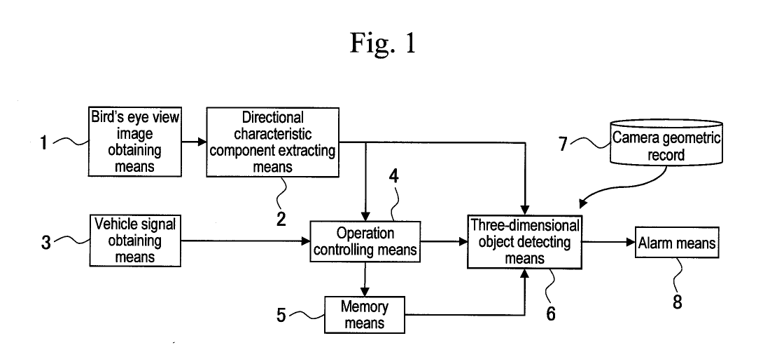

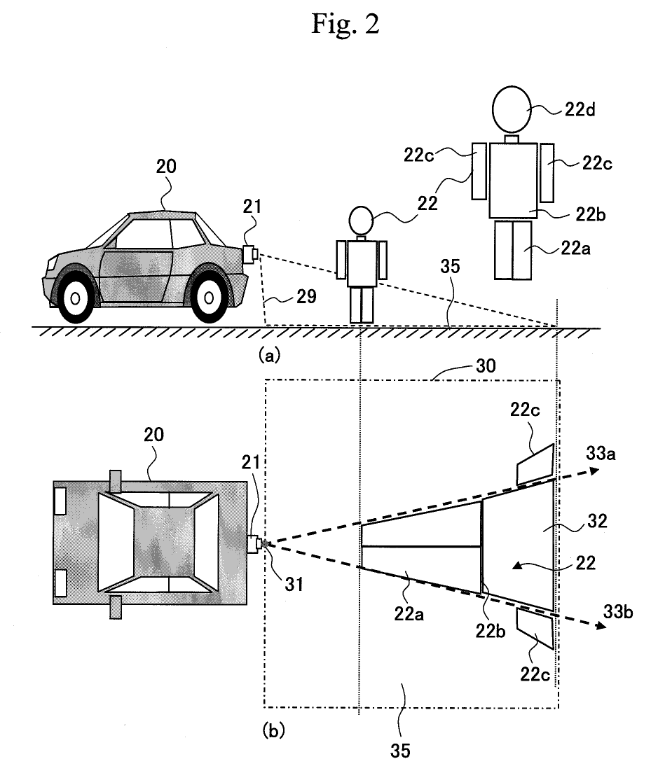

FIG. 1 is a functional block diagram of a three-dimensional object emergence detecting device in the present embodiment. FIG. 2 is a diagram explaining a usage state of the three-dimensional object emergence detecting device. The three-dimensional object emergence detecting device is actualized in a vehicle 20 including at least one or more cameras attached to the vehicle, an arithmetic unit mounted in at least one or more of the camera or the vehicle, a calculator having a main memory and a memory medium, and at least one or more of a monitor screen as a car navigation system or a speaker.

As shown in FIG. 1, the three-dimensional object emergence detecting device includes a bird's-eye view image obtaining means 1, a directional characteristic component extracting means 2, a vehicle signal obtaining means 3, an operation controlling means 4, a memory means 5, a three-dimensional object detecting means 6, a camera geometric record means 7, and an alarm means 8. Each of these means is actualized by the calculator in either of or both of the cameras or the vehicle. The alarm means 8 is actualized by at least one or more of the monitor screen as the car navigation system or the speaker.

The bird's-eye view image obtaining means 1 obtains an image of a camera 21 attached to a vehicle 20 in a predetermined time period. The bird's-eye view image obtaining means 1 corrects lens distortion, and thereafter, creates a bird's-eye view image 30 in which the image of the camera 21 has been projected on the earth surface by means of bird's eye view conversion. It is to be noted that data required for the correction of the lens distortion of the bird's-eye view image obtaining means 1 and the data required for the bird's eye view conversion have been preliminarily prepared, and have been kept in the calculator.

FIG. 2(a) is one example of a situation where the camera 21 attached on the rear of the vehicle 20 has captured, in the space, a three-dimensional object 22 in an angle of view 29 of the camera 21. The three-dimensional object 22 is an upstanding human. The camera 21 is attached at a height of about a waist of the human. The angle of view 29 of the camera 21 has captured a leg 22a, a body 22b, and a lower part of an arm 22c of the three-dimensional object 22.

In FIG. 2(b), numerical symbol 30 denotes the bird's-eye view image; numerical symbol 31 denotes a viewpoint of the camera 21; numerical symbol 32 denotes a form on the bird's-eye view image 30 of the three-dimensional object 22; and numerical symbols 33a and 33b denote view directions from the viewpoint 31 of the camera 21, which pass by both sides of a form 32. The three-dimensional object 22 taken by the camera 21 emerges so as to radially spread from the viewpoint 31 on the bird's-eye view image 30.

For example, in FIG. 2(b), right and left contours of the three-dimensional object 22 are elongated along the view directions 33a and 33b of the camera 21, viewed from the viewpoint 31 of the camera 21. This is because the bird's eye view conversion has properties in that the form on the image is projected on the earth surface, so that when a whole of the form on the image is on the ground surface in the space, the form is not distorted; however, the higher a part of the three-dimensional object 22 photographed on the image is, the larger such distortion becomes; and the form is elongated toward an outside of the image along the view directions from the viewpoint 31 of the camera 21.

It is to be noted that when a height of the camera 21 is higher than a position shown in FIG. 2(a); when a height of the three-dimensional object 22 is lower than a position shown in FIG. 2(a); or when a distance between the three-dimensional object 22 and the camera 21 is closer than a position shown in FIG. 2(a), a range of the three-dimensional object 22 included in the angle of view 29 of the camera 21 is widened, and for example, the angle of view 29 captures the body 22b, an upper part of the leg 22a, and a head 22d.

However, as in FIG. 2(b), the form 32 of the three-dimensional object 22 on the bird's-eye view image 30 shows the same tendency in which it is elongated along the view directions 33a and 33b, both of which are directions radially extending from the viewpoint 31 of the camera 21.

Additionally, when the height of the camera 21 is lower than the position shown in FIG. 2(a); when the height of the three-dimensional object 22 is higher than the position shown in FIG. 2(a); or when the distance between the three-dimensional object 22 and the camera 21 is farther than the position shown in FIG. 2(a), the range of the three-dimensional object 22 included in the angle of view 29 of the camera 21 is narrowed, and for example, the angle of view 29 captures only the leg 22a. However, as in FIG. 2(b), the form 32 of the three-dimensional object 22 on the bird's-eye view image 30 shows the same tendency in which it is elongated along the view directions 33a and 33b, both of which are directions radially extending from the viewpoint 31.

In the case where the three-dimensional object 22 is a human, the human is not necessarily upstanding, and an upstanding posture may be somewhat deformed due to bending of joints of the arms 22c and the leg 22a. However, in a range where a whole silhouette of the human is vertically long, as in FIG. 2(b), the visual performance of the three-dimensional object 22 shows the same tendency in which it is elongated along the view directions 33a and 33b of the camera 21.

Even in the case where the human of the three-dimensional object 22 crouches down, the silhouette is vertically long as a whole, so that as in FIG. 2(b), the visual performance of the three-dimensional object 22 shows the same tendency in which it is elongated along the view directions 33a and 33b of the camera 21. Additionally, in the above-mentioned explanation of FIG. 2, a human has been taken for example as the three-dimensional object 22. However, the three-dimensional object 22 is by no means limited to a human. If the three-dimensional object 22 is an object having a width and a height near to those of a human, the visual performance of the three-dimensional object 22 shows the same tendency in which it is elongated along the view directions 33a and 33b of the camera 21.

In each of FIG. 2(a) and FIG. 2(b), there has been shown the example in which the camera 21 is attached on the rear of the vehicle 20. However, an attachment position of the camera 21 may be in another direction such as in front of or at the side of the vehicle 20. Additionally, in FIG. 2(b), there has been shown the example in which the viewpoint 31 of the camera 21 on the bird's-eye view image 30 is set to be at a center of a left end of the bird's-eye view image 30. However, even if the viewpoint 31 of the camera 21 is attached to any place such as a center of an upper end or a corner of an upper right of the bird's-eye view image 30, the three-dimensional object 22 shows the same tendency in which it is elongated along the view directions 33a and 33b of the camera 21.

The directional characteristic component extracting means 2 obtains horizontal gradient strength H and vertical gradient strength V, which the respective pixels of the bird's-eye view image 30 has, and obtains a light-dark gradient directional angle 0 defined by these horizontal gradient strength H and vertical gradient strength V.

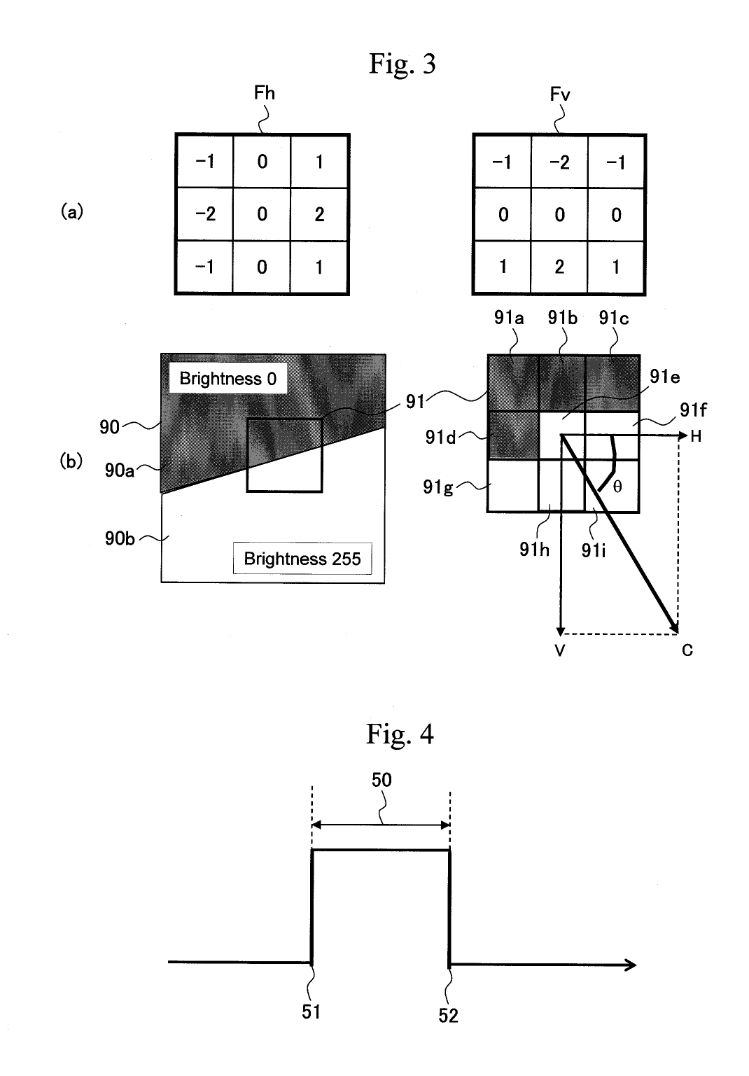

The horizontal gradient strength H is obtained by a convolution operation through use of brightness of a neighborhood pixel located in the neighborhood of a target pixel and coefficients of a horizontal Sobel filter Fh shown in FIG. 3(a). The vertical gradient strength V is obtained by the convolution operation through use of the brightness of the neighborhood pixel located in the neighborhood of the target pixel and the coefficient of a vertical Sobel filter Fv shown in FIG. 3(b).

The light-dark gradient directional angle 0 defined by the horizontal gradient strength H and the vertical gradient strength V is obtained through use of the following formula.

[Formula 1]

θ=tan⁻¹(V/H) (1)

In the above-described Formula (1), the light-dark gradient directional angle θ represents an angle of in which direction a contrast of the brightness within a local range of three pixels by three pixels is changed.

The directional characteristic component extracting means 2 calculates the light-dark gradient directional angle θ as to all of the pixels on the bird's-eye view image 30 though use of the above-described Formula 1, and outputs the angle θ as directional characteristic components of the bird's-eye view image 30.

FIG. 3(b) is one example of the calculation of the light-dark gradient directional angle θ through use of the above-described Formula 1. Numerical symbol 90 denotes an image in which the brightness of a pixel area 90a on the upper side is 0, whereas the brightness of a pixel area 90b on the lower side is 255; and each of the upper side and the lower side has a right oblique boundary. Numerical symbol 91 is an image that enlargedly shows an image block of three pixels by three pixels near the boundaries on the upper side and on the lower side of the image 90.

The brightness of the respective pixels of upper-left 91a, upper 91b, upper-right 91c, and left 91d of the image block 91 is 0. The brightness of the respective right 91f, central 91e, lower-left 91g, lower 91h, and lower-right 91i is 255. At this time, the gradient strength H, which is a value of the convolution operation of the central pixel 91e through use of the coefficients of the horizontal Sobel filter Fh shown in FIG. 3(a), is 255, which is calculated by the following formula: −1×0+0×0+1×0−2×0+0×0+1×255−1×255+0×0+1×255.

The gradient strength V, which is a value of the convolution operation of the central pixel 91e through use of the coefficients of the vertical Sobel filter Fv, is 1020, which is calculated by the following formula: −1×0−2×0−0×0+0×0+0×0+0×255+1×255+2×255+1×255.

At this time, the light-dark gradient directional angle θ through use of the above-mentioned Formula (1) is approximately 76 degrees, and indicates an approximately lower-right direction in the same manner as the upper and lower boundaries of the image 90. It is to be noted that the coefficients used by the directional characteristic component extracting means 2 for obtaining the gradient strengths H and V or a size of the convolution are by no means limited to the ones shown in FIG. 3(a) and FIG. 3(b), and may be others if the horizontal and vertical gradient strengths H and V can be obtained through use thereof.

Additionally, the directional characteristic component extracting means 2 may be another method other than the one using the light-dark gradient directional angle θ defined by the horizontal gradient strength H and the vertical gradient strength V, if such method is capable of extracting the direction of the contrast of the brightness (light-dark gradient direction) within the local range. For example, high-level local auto-correlation of Non-Patent Document 1 or Edge of Orientation Histograms of Non-Patent Document 2 can be used for the extraction of the light-dark gradient directional angle θ by the directional characteristic component extracting means 2.

The vehicle signal obtaining means 3 obtains, from a control device of the vehicle 20 and the calculator in the vehicle 20, a state of ON or OFF of an ignition switch, a state of an engine key such as ON of an accessory power source, a signal of a state of a gear such as forward movement, backward movement, parking, an operational signal of the car navigation system, and a vehicle signal such as time information.

As illustrated in, for example, FIG. 4, the operation controlling means 4 determines a start point 51 and an end pint 52 of an interval 50 where an attention of a driver of the vehicle 20 is temporarily distracted from confirmation of surroundings of the vehicle 20, based on the vehicle signal from the vehicle signal obtaining means 3.

One example of the interval 50 includes, for example, a brief stop of the vehicle in order for the driver to carry baggage in the vehicle 20, or to carry the baggage out of the vehicle 20. In order to determine this brief stop of the vehicle, the signal when the ignition switch has been turned OFF from ON is taken as the start point 51, and the signal when the ignition switch has been turned ON from OFF is taken as the end point 52.

In addition, one example of the interval 50 includes, for example, a situation where the driver operates a car navigation device during stopping the vehicle to search a destination, and after setting of its route, starts the vehicle again. In order to determine the stop/the start of the vehicle for such operation of the car navigation device, the signal of vehicle speed or a brake and the signal of the start of the operation of the car navigation device are taken as the start point 51, and the signal of termination of the operation of the car navigation device and the signal of the brake are taken as the end point 52.

Here, regarding the operation controlling means 4, in the case where image quality of the camera 21 of the vehicle 20 is unstable immediately after the end point 52, such as a situation where power supply of the vehicle 20 to the camera 21 is cut off at timing of the start point 51, and the power supply of the vehicle 20 to the camera 21 is resumed at the timing of the end point 52, the timing when a predetermined delay time is provided from the timing when an end of the interval 50 shown in FIG. 4 is determined based on the signal from the vehicle signal obtaining means 3 may be taken as the end point 52.

When determining the timing of the start point 51, the operation controlling means 4 transmits, at that point, to the memory means 5 the directional characteristic components output from the directional characteristic component extracting means 2. Additionally, when determining the timing of the end point 52, the operation controlling means 4 outputs a signal of determination of detection to the three-dimensional object detecting means 6.

The memory means 5 holds stored information so as for such information not to be erased during the interval 5 shown in FIG. 4. The memory means 5 is actualized by the memory medium to which power is supplied also during the time when the ignition switch is turned OFF during the interval 50, or by the memory medium such as a flash memory or a hard disk in which information is not erased during a predetermined time even if the power is not supplied.

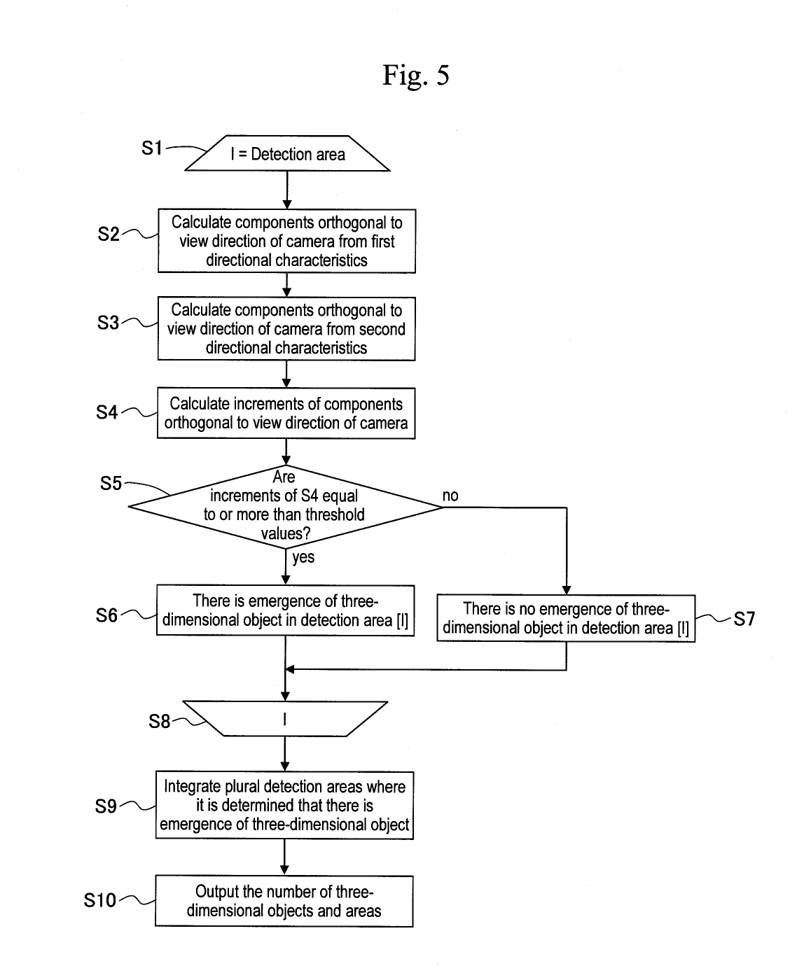

FIG. 5 is a flowchart showing a processing content of the three-dimensional object detecting means 6. When receiving the signal of the determination of detection from the operation controlling means 4, the three-dimensional object detecting means 6 executes processing of detecting the three-dimensional object on the bird's-eye view image 30 in accordance with a flow shown in FIG. 5.

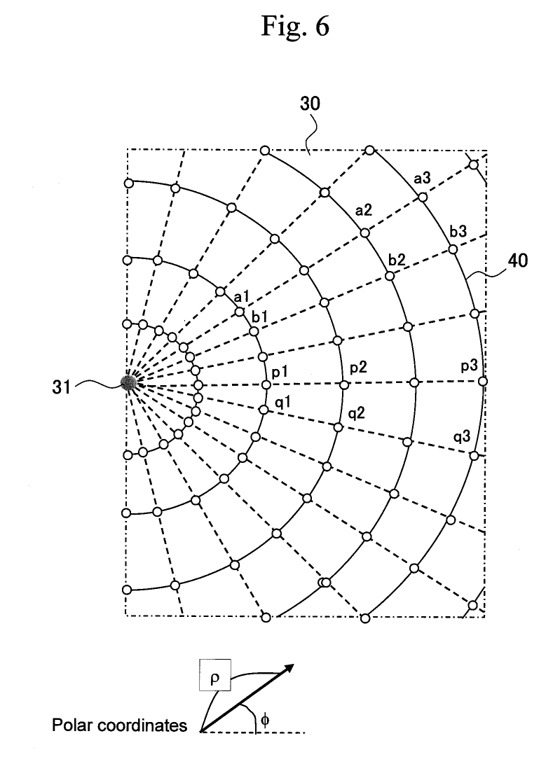

In FIG. 5, the flow from Step S1 to Step S8 is loop processing of the detection area provided on the bird's-eye view image 30. FIG. 6 is a drawing for explaining the loop processing of the detection area from Step S1 to Step S8. A coordinate grid 40 is made by partitioning the bird's-eye view image 30 in lattice form through use of polar coordinates of a distance ρ and an angle φ with a central focus on the viewpoint 31 of the camera 21, as shown in FIG. 6.

The detection area of the bird's-eye view image 30 is provided by totally combining the intervals of the distances ρ of the coordinate grid 40 per the angle φ of the polar coordinates of the coordinate grid 40. For example, on FIG. 6, the area in which (a1, a2, b2, and b1) are taken as four apexes is one detection area, and each of the areas of (a1, a3, b3, and b1) and (a2, a3, b3, and b2) is also one detection area.

For the viewpoint 31 of the camera 21 on the bird's-eye view image 30 and a lattice of the polar coordinates of FIG. 6, used is data preliminarily calculated and stored in the camera geometric record 7. The loop processing from Step S1 to Step S8 exhaustively repeats this detection area. Hereinafter, in explanations of Step S2 to Step S7, the detection area of a loop will be expressed as a detection area [I].

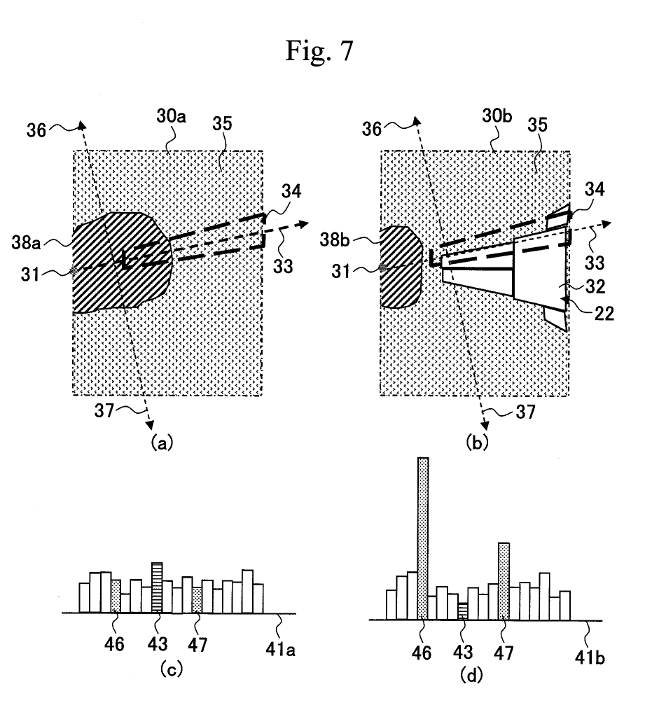

FIG. 7 is a drawing for explaining the processing from Step S2 to Step S7 in FIG. 5. FIG. 7(a) is one example of the bird's-eye view image 30, and shows a bird's-eye view image 30a that has captured a shadow 38a of the vehicle 20 and a gravel road surface 35. FIG. 7(b) is one example of the bird's-eye view image 30, and shows a bird's-eye view image 30b that has captured the three-dimensional object 22 and a shadow 38b of the vehicle 20.

FIG. 7(a) and FIG. 7(b) are the images 30a and 30b, respectively, both of which have been photographed by the vehicle 20 at the same spots. In FIG. 7(a) and FIG. 7(b), due to the change in sunshine, the positions or the sizes of the shadows 38a and 38b of the vehicle 20 are changed. In FIG. 7(a) and FIG. 7(b), numerical symbol 34 denotes the detection area [I]; numerical symbol 33 denotes the view direction facing the center of the detection area [I] 34 from the viewpoint 31 of the camera 21; numerical symbol 36 denotes an orthogonal direction that is the direction along a face of the bird's-eye view image 30 and rotates by minus 90 degrees from the view direction 33 to intersect therewith; numerical symbol 37 denotes the orthogonal direction that is the direction along the face of the bird's-eye view image 30 and rotates by plus 90 degrees from the view direction 33 to intersect therewith. The detection area [I] is the area where the direction φ is identical on the coordinate grid 40. Thus, a detection area [I] 34 extends toward an outside of the bird's-eye view image 30 along the view direction 33 from the viewpoint 31 side of the camera 21.

FIG. 7(c) shows a histogram 41a of the light-dark gradient directional angle θ obtained by the directional characteristic component extracting means 2 from the bird's-eye view image 30a. FIG. 7(d) shows a histogram 41b of the light-dark gradient directional angle θ obtained by the directional characteristic component extracting means 2 from the bird's-eye view image 30b. The histograms 41a and the histogram 41b obtain the light-dark gradient directional angle θ, which has been calculated by the directional characteristic component extracting means 2, through discretization of such angle θ using the following Formula 2.

[Formula 2]

θ_{bin}=Int(θ/θ_{TICS})

In the above-mentioned Formula 2, θ_{ICS} represents a pitch of the discretization of the angle, and INT( ) represents a function that rounds down numerals after the decimal point to make the remaining numerals an integer. θ_{TICS} may be preliminarily determined to the extent that the contour of the three-dimensional object 22 is deviated from the view direction 33, or in response to disarray of the image quality. For example, in the case where the three-dimensional object 22 targets a walking human, or in the case where the disarray of the image quality is large, θ_{TICS} may be made large so as to tolerate fluctuations in the contour of the three-dimensional object 22 due to the walking of the human or variations of the respective pixels of the light-dark gradient directional angle θ calculated by the directional characteristic component extracting means 2 due to the disarray of the image. It is to be noted that in the case where the disarray of the image is small and the fluctuations in the contour of the three-dimensional object 22 are also small, θ_{ICS} may be made small.

In FIG. 7(c) and FIG. 7(d), numerical symbol 43 denotes the directional characteristic components of the view direction 33 in which the light-dark gradient directional angle θ is oriented from the viewpoint 31 of the camera 21 to the detection area [I] 34; numerical symbol 46 denotes an orthogonal-direction characteristic component that is the directional characteristic component oriented to the orthogonal-direction 36 in which the light-dark gradient directional angle θ is rotated by minus 90 degrees from the view direction 33; and numerical symbol 47 denotes the orthogonal-direction characteristic component that is the directional characteristic component oriented to the orthogonal direction 37 in which the light-dark gradient directional angle θ is rotated by plus 90 degrees from the view direction 33.

The road surface 35 in the detection area 34 of the bird's-eye view image 30a is gravel, and a pattern of the gravel locally faces a random direction. Accordingly, the light-dark gradient directional angle θ calculated by the view direction detecting means 2 is not biased. Additionally, the shadow 38a in the detection area 34 of the bird's-eye view image 30a has a light and dark contrast at a boundary part between the shadow 38a and the road surface 35. However, a segment length of the boundary part between the shadow 38a and the road surface 35 in the detection area [I] 34 is shorter compared with a case of the three-dimensional object 22 such as a human, and an influence due to the aforementioned contrast is small. Thus, in the histogram 41a of the light-dark gradient directional angle θ obtained from the bird's-eye view image 30a, the directional characteristic components are not strongly biased as shown in FIG. 7(c), and a frequency (amount) of any component tends to vary.

Meanwhile, in the bird's-eye view image 30b, the boundary part between the three-dimensional object 22 and the road surface 35 is included in the detection area [I] 34 along the distance ρ direction of the polar coordinates, and there is the strong contrast in a direction intersecting with the view direction 33. Thus, in the histogram 41b of the light-dark gradient directional angle θ obtained from the bird's-eye view image 30b, an orthogonal-direction characteristic component 46 or an orthogonal-direction characteristic component 47 has the large frequency (amount).

It is to be noted that in FIG. 7(d), there was shown the example in which the frequency of the orthogonal-direction characteristic component 47 in the histogram 41b became high (the amount thereof became large). However, in practice, it is by no means limited to this example. When the brightness of the three-dimensional object 22 is lower than that of the road surface 35 as a whole, the frequency of the orthogonal-direction characteristic component 47 becomes high (the amount thereof becomes large). When the brightness of the three-dimensional object 22 is higher than that of the road surface 35 as a whole, the frequency of the orthogonal-direction characteristic component 46 becomes high (the amount thereof becomes large). If the bias occurs in the detection area [I] 34 where the three-dimensional object 22 or the road surface has the high brightness, the frequencies of both of the orthogonal-direction characteristic component 46 and the orthogonal-direction characteristic component 47 become high (the amounts thereof become high).

In Step S2 of FIG. 5, as first orthogonal-direction characteristic components, the orthogonal-direction characteristic components 46 and 47 are obtained from the detection area [I] 34 of the bird's-eye view image 30a in the start point 51 (refer to FIG. 4) stored in the memory means 5. In Step S3, as second orthogonal-direction characteristic components, the orthogonal-direction characteristic components 46 and 47 are obtained from the detection area [I] 34 of the bird's-eye view image 30b in the end point 52 (refer to FIG. 4).

In the processing of Step S2 and Step S3, among the directional characteristic components of the histograms illustrated in FIG. 7(c) and FIG. 7(d), those other than the orthogonal-direction characteristic components 46 and 47 are not used, and thus, may be not calculated. Additionally, the orthogonal-direction characteristic components 46 and 47 can be calculated through use of an angle other than the angle θ_{bin} discretized by the above-mentioned Formula 2.

For example, given that the angle of the view direction 33 is and an acceptable error from the view direction 33 of the contour of the form 32 in consideration of the walking of the human or the disarray of the image is ε, the orthogonal-direction characteristic component 46 can be calculated by the number of the pixels having the angle θ in the range of (η−90±ε) in the detection area [I] 34; whereas the orthogonal-direction characteristic component 47 can be calculated by the number of the pixels having the angle θ in the range of (η+90±ε) in the detection area [I] 34.

In Step S4 of FIG. 5, from a frequency Sₐ₋ of the first orthogonal-direction characteristic component 46 and a frequency Sₐ₊ of the orthogonal-direction characteristic component 47, both of such components having been obtained in Step S2; a frequency S_{b-} of the second orthogonal-direction characteristic component 46 and a frequency S_{b+} of the orthogonal-direction characteristic component 47, both of such components having been obtained in Step S3; by use of the following Formula 3, Formula 4, and Formula 5, calculated is an increment ΔS₊, ΔS₋, or ΔS_{±} of the orthogonal-direction characteristic components 46 and 47 in a generally orthogonal direction (including the orthogonal direction) that is the direction nearly orthogonal to the view direction 33.

[Formula 3]

ΔS₊=S_{b+}−Sₐ₊ (3)

[Formula 4]

S₋=S_{b-}−Sₐ₋ (4)

[Formula 5]

ΔS_{±}=ΔS₊+ΔS₋ (5)

In Step S5 of FIG. 5, determined is whether or not the increments of the orthogonal-direction characteristic components 46 and 47 calculated in Step S4 are equal to or more than predetermined threshold values. When such increments are equal to or more than the threshold values, it is determined that during the interval 50 from the start point 51 to the end point 52 shown in FIG. 4, the three-dimensional object 22 has emerged in the detection area [I] 34 (Step S6).

Meanwhile, when the increments of the orthogonal-direction characteristic components 46 and 47 calculated in Step S4 is less than the predetermined threshold values, it is determined that during the interval 50 shown in FIG. 4, the three-dimensional object 22 has not emerged in the detection area [I] 34 (Step S7).

For example, in the case where the bird's-eye view image 30a shown in FIG. 7(a) is an image at the start point 51, and the bird's-eye view image 30b shown in FIG. 7(b) is an image at the end point 52, in the histogram 41b calculated in Step S3, compared with the histogram 41a calculated in Step S2, the frequencies of the orthogonal-direction characteristic, components 46 and 47 become higher due to the form 32 of the three-dimensional object 22 in FIG. 7(b); the increments of the orthogonal-direction characteristic components 46 and 47 in the detection area [I] 34 calculated in Step S4 become larger; and in Step S6, it is determined that there is the emergence of the three-dimensional object 22.

In contrast, in the case where the bird's-eye view image 30b shown in FIG. 7(b) is the image at the start point 51, and the bird's-eye view image 30a shown in FIG. 7(a) is the image at the end point 52, in the histogram 41a calculated in Step S2, compared with the histogram 41b calculated in Step S3, the frequencies of the orthogonal-direction characteristic components 46 and 47 become lower due to the form 32 of the three-dimensional object 22 in FIG. 7(b), and in Step S7, it is determined that there is no emergence of the three-dimensional object 22.

In the case where the three-dimensional object 22 has not emerged during the interval 50 shown in FIG. 4, and a background of the detection area [I] 34 is not changed, either, the first orthogonal-direction characteristic components 46 and 47 are approximately equal to the second orthogonal-direction characteristic components 46 and 47, and the increments of the orthogonal-direction characteristic components calculated in Step S4 are very few. Accordingly, in Step S7, it is determined that the three-dimensional object 22 has not emerged.

Additionally, in the case where the three-dimensional object 22 has not emerged during the interval 50 shown in FIG. 4, however, the background of the detection area [I] 34 is changed; for example, even in the case where the brightness is changed as a whole due to sunshine variation or movement of the shadow etc,; as long as the change in the background does not appear along the view direction 33; the first orthogonal-direction characteristic components 46 and 47 are approximately equal to the second orthogonal-direction characteristic components 46 and 47; and in Step S7, it is determined that the three-dimensional object 22 has not emerged.

Meanwhile, in the case where although there is the emergence of the three-dimensional object 22 during the interval 50 shown in FIG. 4, the orthogonal-direction characteristic components 46 and 47 in the background of the detection area [I] 34 at the start point 51 are close to the orthogonal-direction characteristic components 46 and 47 of the three-dimensional object 22 at the end point 52, for example, in the case where there is a white line or a strut extending in the view direction 33 in the background of the detection area [I] 34 at the start point 51, the increments of the directional characteristics in an intersecting direction of the view direction 33 calculated in Step S4 are very few, and in Step S7, it is determined that there is no emergence of the three-dimensional object 22.

Step S9 of FIG. 5 is the loop processing from Step S1 to Step S8. In the case where it is determined that there is the emergence of the three-dimensional object 22 in two or more of the detection areas [I], executed is the processing in which the detection areas where it is determined that there is the emergence of the three-dimensional object 22 are integrated into one detection area in such a manner that the identical three-dimensional objects 22 in the space respond to one detection area as much as possible,.

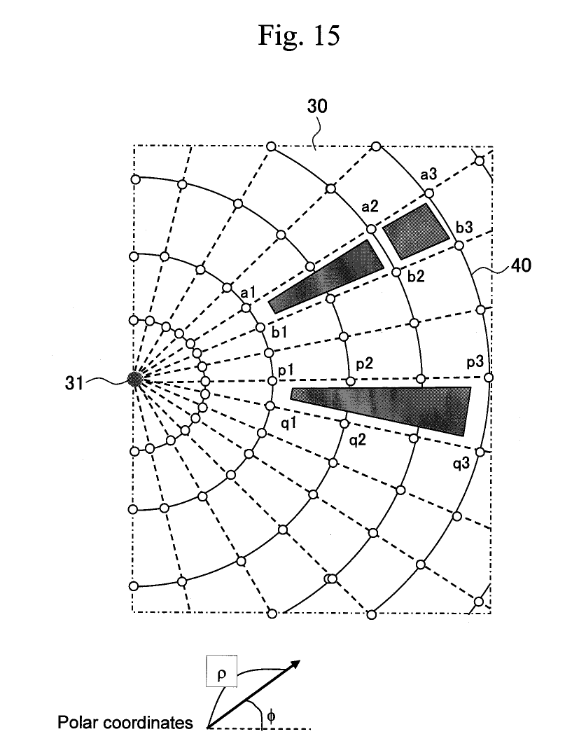

In Step S9, first, the detection areas are integrated in the distance ρ direction of the identical direction φ on the polar coordinates. For example, as shown in FIG. 15, in the case where it is determined that in the detection areas of (a1, a2, b2, b1) and (a2, a3, b3, b2), there is the emergence of the three-dimensional object 22, the integration is executed in such a manner that it is determined that in the detection area of (a1, a3, b3, b1), there is the emergence of the three-dimensional object 22.

Next, in Step S9, among the detection areas integrated in the distance ρ direction on the polar coordinates, ones whose directions φ on the polar coordinates are close are integrated into one detection area. For example, as shown in FIG. 15, when it is determined that there is the emergence of the three-dimensional object 22 in the detection area of (a1, a3, b3, b1); and there is the emergence of the three-dimensional object 22 in the detection area of (p1, p2, q2, q1), since a difference in the directions φ of the two detection areas is small, (a1, a3, q3, q1) is taken as one detection area. Regarding a range of the direction φ for integrating the detection areas, an upper limit is preliminarily determined depending on an apparent size of the three-dimensional object 22 on the bird's-eye view image 30.

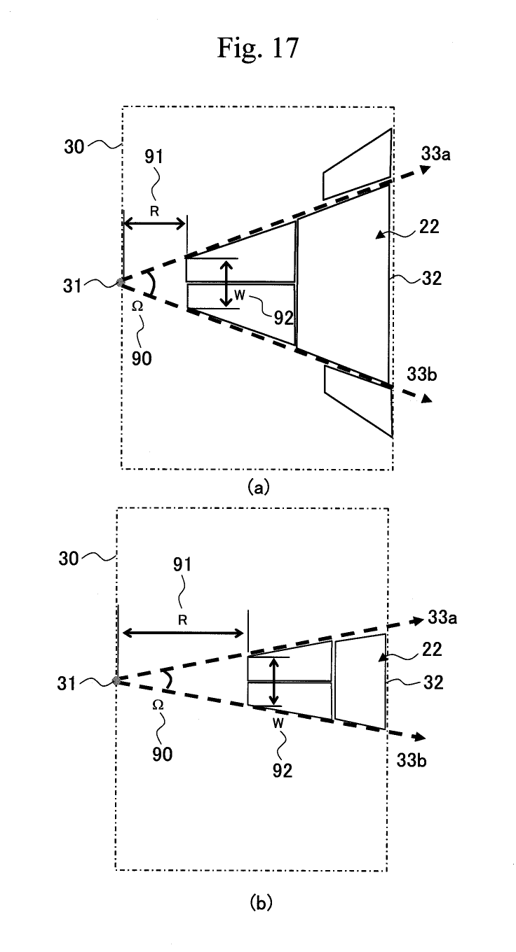

FIG. 17(a) and FIG. 17(b) are the drawings for supplementarily explaining the processing of Step S9. Numerical symbol 92 denotes a width W at a foot on the bird's-eye view image 30. Numerical symbol 91 denotes a distance R from the viewpoint 31 of the camera 21 on the bird's-eye view image 30 to the foot of the three-dimensional object 22. Numerical symbol 90 denotes an apparent angle Ω at the foot of the three-dimensional object 22 viewed from the viewpoint 31 of the camera 21 on the bird's-eye view image 30.

The angle Ω 90 is uniquely determined from the width W 92 at the foot and the distance R 91. Given that the widths W 92 are the same, when the three-dimensional object 22 is close to the viewpoint 31 of the camera 21 as shown in FIG. 17(a), the distance R 91 becomes short and the angle Ω 90 becomes large, and contrarily, when the three-dimensional object 22 is far from the viewpoint 31 of the camera 21 as shown in FIG. 17(b), the distance R 91 becomes long and the angle Ω 90 becomes small.

The three-dimensional object emergence detecting device of the present invention targets, for the detection, the three-dimensional object 22 having the width and the height close to those of a human among the three-dimensional objects. Thus, it is possible to preliminarily estimate a range of the width at the foot in the space of the three-dimensional object 22. Therefore, it is possible to preliminarily estimate the range of the width W 92 at the foot of the three-dimensional object 22 on the bird's-eye view image 30 from the range of the width at the foot of the three-dimensional object 22 in the space and calibration data of the camera geometric record 7.

From this preliminarily estimated range of the width W 92 at the foot, it is possible to calculate the range of the apparent angle Ω 90 at the foot with respect to the distance R 91 to the foot. The range of the angle φ for integrating the detection areas in Step S9 is determined through use of the distance from the detection area on the bird's-eye view image 30 to the viewpoint 31 of the camera 21, and a relationship between the above-mentioned distance R 91 to the foot and the apparent angle Ω 90 at the foot.

The method for integrating the detection areas of Step S9 mentioned above is merely one example. Any method, which integrates the detection areas in the range depending on the apparent size of the three-dimensional object 22 on the bird's-eye view image 30, is applicable to the method for integrating the detection areas of Step S9. For example, any method, which calculates the distance between the detection areas where it is determined that there is the emergence of the three-dimensional object 22 on the coordinate partitioning 40 and forms a group of the adjacent detection areas or that of the detection areas whose distances are close in the range of the apparent size of the three-dimensional object 22 on the bird's-eye view image 30, is applicable to the method for integrating the detection areas of Step S9.

It is to be noted that in the descriptions of Step S5, Step S6, and Step S7, the explanations have been made that even in the case where the three-dimensional object 22 has emerged during the interval 50 shown in FIG. 4, among the detection areas [I], regarding the detection area [I] at the start point 51 whose background has the orthogonal-direction characteristic components 46 and 47 close to the three-dimensional object 22 in the detection area [I] at the end point 52, it is determined that the three-dimensional object 22 has not emerged. However, in the case where in the range of the detection area [I] including the silhouette of the three-dimensional object 22, the orthogonal-direction characteristic components 46 and 47 are different between the background at the start point 51 and the three-dimensional object 22 at the end point 52, it is possible to detect the emergence of the three-dimensional object 22 in Step S9 where determination results of the plural detection areas [I] are integrated and make a decision.

Additionally, regarding the coordinate partitioning 40 of the loop processing from Step S1 to Step S8, grid partitioning of the polar coordinates shown in FIG. 6 is merely one example of the coordinate partitioning 40. Any coordinate system, which has two coordinate axes of the coordinate axis in the distance ρ direction and the coordinate axis in the angle φ direction, is applicable to the coordinate partitioning 40.

Moreover, partitioning intervals of the distance ρ and the angle φ of the coordinate partitioning 40 are arbitrary. The smaller the partitioning intervals of the coordinate partitioning 40 becomes, the more exerted, in Step S4, is an advantage that the emergence of the small three-dimensional object 22 can be detected based on the local increments of the orthogonal-direction characteristic components 46 and 47 on the bird's-eye view image 30. Meanwhile, produced is a disadvantage that the number of the detection areas, in which the integration is determined in Step S9, increases and thus a calculation amount increases. It is to be noted that when the partitioning intervals of the coordinate partitioning 40 are made the smallest, the initial detection area of the coordinate partitioning 40 becomes one pixel on the bird's-eye view image.

In Step S10 of FIG. 5, calculated and output are the number of the detection areas integrated in Step S9, a central position or a central direction per detection area, and the distance from the detection area to the viewpoint 31 of the camera 21. In FIG. 1, the camera geometric record 7 accumulates the viewpoint 31 of the camera 21 on the bird's-eye view image 30, the grid of the polar coordinates of FIG. 6, and numerical data used in the three-dimensional object detecting means 6, all of which have been preliminarily obtained. Additionally, the camera geometric record 7 includes the calibration data that associates coordinates at points in the space with the coordinates at the points on the bird's-eye view image 30.

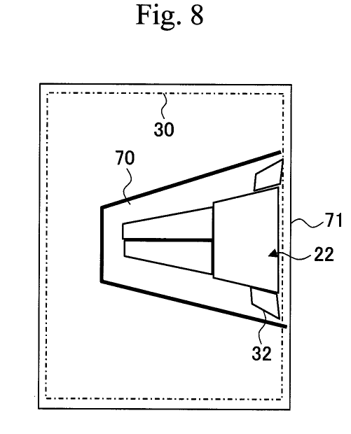

In FIG. 1, when the three-dimensional object detecting means 6 detects the emergence of one or more of the three-dimensional objects, the alarm means 8 outputs an alarm that alerts a driver through either of a screen output or an audio output or through both thereof. FIG. 8 is one example of the screen output of the alarm means 8. Numerical symbol 71 denotes a screen display. Numerical symbol 70 denotes a broken line (frame line) showing the three-dimensional object 22 on the screen display 71. In FIG. 8, the screen display 71 shows generally a whole of the bird's-eye view image 30. The broken line 70 is the detection area where the three-dimensional object detecting means 6 has determined that there is the emergence of the three-dimensional object 22, or an area where an adjustment in appearance is added to the detection area where the three-dimensional object detecting means 6 has determined that there is the emergence of the three-dimensional object 22.

It is to be noted that the three-dimensional object detecting means 6 adopts a method for detecting the three-dimensional object 22 from the two bird's-eye view images 30 of the start point 51 and the end point 52 on the basis of the increments of the orthogonal-direction characteristic components 46 and 47. Accordingly, the three-dimensional object detecting means 6 can correctly extract the silhouette of the three-dimensional object 22 as long as a disturbance, such as the shadow of the three-dimensional object 22 or the shadow of the own vehicle 20, does not incidentally overlap with the view direction 33 of the camera. Therefore, the broken line 70 is drawn along the silhouette of the three-dimensional object 22 in most cases, and a driver can comprehend a shape of the three-dimensional object 22 from the broken line 70.

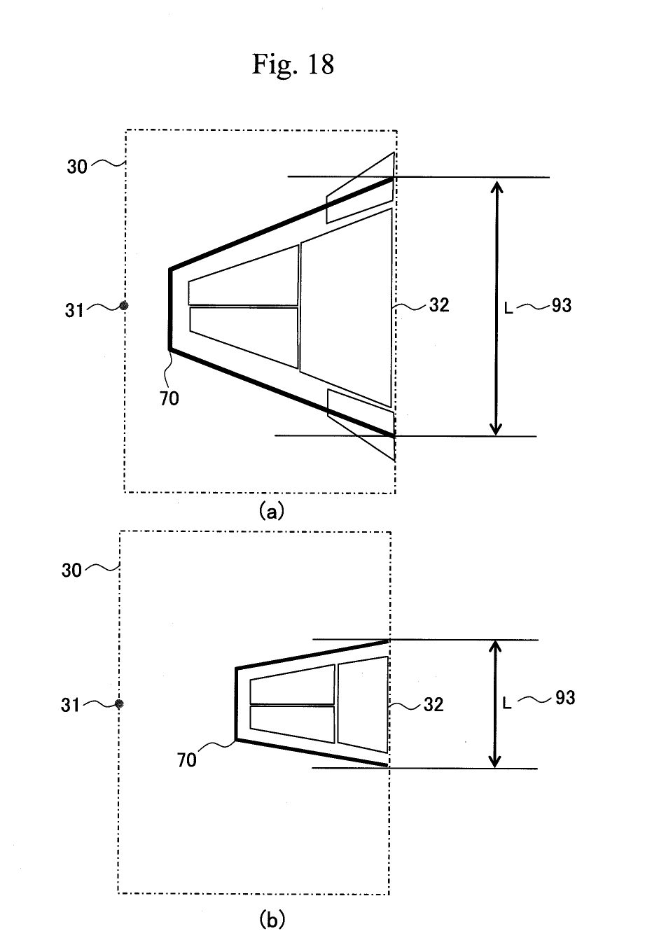

FIG. 18 is a drawing for explaining a change in the broken line 70 depending on the distance from the three-dimensional object 22 to the camera 21. First, as shown in FIG. 17(a), the closer to the viewpoint 31 of the camera 21 the three-dimensional object 22 is, the larger the apparent angle Ω 90 of the three-dimensional object 22 becomes. In contrast, as shown in FIG. 17(b), the farther from the viewpoint 31 of the camera 21 the three-dimensional object 22 is, the smaller the apparent angle Ω 90 becomes. Due to this properties of the angle Ω 90 of the three-dimensional object 22 and because of a point that the broken line 70 is drawn along the silhouette of the three-dimensional object 22 in most cases, as in FIG. 18(a), the closer to the viewpoint 31 of the camera 21 the three-dimensional object 22 is, the wider a width L 93 of the broken line 70 becomes. In contrast, as in FIG. 18(b), the farther from the viewpoint of the camera 21 the three-dimensional object 22 is, the narrower the width L 93 becomes. Thus, a driver can comprehend a sense of distance between the three-dimensional object 22 and the camera 21 from the width L 93 of the broken line 70 on the screen display 71.

It is to be noted that the alarm means 8 may draw a graphic close to the silhouette of the three-dimensional object 22 on the bird's-eye view image 30 in place of the broken line 70 in the screen display 71. For example, the alarm means 8 may draw a parabolic line in place of the broken line 70.

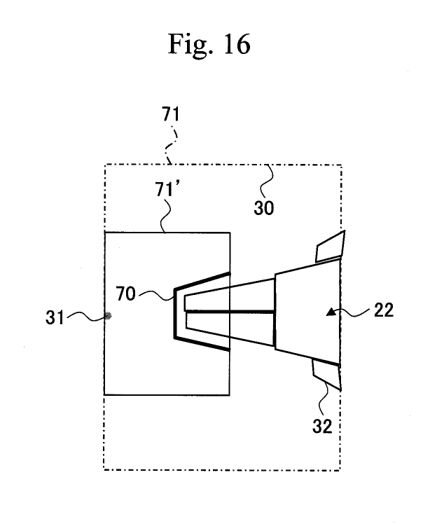

FIG. 16 is a drawing showing another example of the screen output of the alarm means 8. In FIG. 16, a screen display 71′ shows a range near the viewpoint 31 of the camera 21 on the bird's-eye view image 30. When comparing the screen display 71 with the screen display 71′, the screen display 71′ narrows down a display range on the bird's-eye view image 30, thereby enabling to display, at high resolution, a curb, a car stop, or the like in the close vicinity of the viewpoint 31 of the camera 21, namely, in the close vicinity of the vehicle 20 in such a manner that a driver easily performs visual observation.

It is to be noted that in order to display the vicinity of the vehicle 20, also considerable is a configuration in which the angle of view of the bird's-eye view image 30 is set in the neighborhood of the vehicle 20, and a whole of the bird's-eye view image 30 is used for the screen display 71. However, if the angle of view of the bird's-eye view image 30 is narrowed, the extension of the three-dimensional object 22 along the view direction 33 becomes small. Thus, it is difficult for the three-dimensional object detecting means 6 to detect the three-dimensional object 22 with favorable precision. For example, in the case where the angle of view of the bird's-eye view image 30 is narrowed to a range of the screen display 71′, only the foot of the three-dimensional object 22 is included in the angle of view of the bird's-eye view image 30. Thus, in comparison with the case where portions from the leg 22a to the body 22b of the three-dimensional object 22 are included in the angle of view of the bird's-eye view image 30 as in FIG. 8, the extension of the three-dimensional object 22 along the view direction 33 is small, resulting in difficulty in detecting the three-dimensional object 22.

The alarm means 8 may be fabricated so as to be rotated to change its direction, or fabricated so as to adjust the brightness for further improving visibility of the screen display 71 whose example has been shown in FIG. 8 or FIG. 16. Additionally, as the configuration shown in the above-mentioned Patent Document 1, in the case where two or more of the cameras 21 are attached to the vehicle 20, the plural screen displays 71 may be synthesized in a lump in such a manner that a driver can give a glance to the plural screen displays 71 of the plural cameras 21.

In addition to an alarm sound such as a peeping sound, the audio output of the alarm means 8 may be an announcement for explaining a content of the alarm, such as “Some kind of three-dimensional object seems to have emerged around the vehicle” or “Some kind of three-dimensional object seems to have emerged around the vehicle. Please confirm the monitor screen,” or both of the alarm sound and the announcement.

In Embodiment 1 of the present invention, according to the above-described functional configurations, the comparison of the images before and after the driver's attention is temporarily deviated from the confirmation of the surroundings of the vehicle 20 is determined based on the increments of the orthogonal-direction characteristic components that are the directional characteristic components each having the direction orthogonal to the view direction from the viewpoint 31 of the camera 21 among the directional characteristic components on the bird's-eye view image 30, whereby it is possible to draw the attention to the surroundings of a driver attempting to start the vehicle 20 again by outputting the alarm when the three-dimensional object 22 has emerged during the time when the confirmation of the surroundings is ceased.

Additionally, the changes in the images before and after the driver's attention is temporarily deviated from the confirmation of the surroundings of the vehicle 20 are narrowed down to the increments of the orthogonal-direction characteristic components each having the direction nearly orthogonal to the view direction from the viewpoint 31 of the camera 21 on the bird's-eye view image 30, whereby it is possible to suppress erroneous reports due to erroneous detection of those other than an emerged object, such as the changes in the shadow of the own vehicle 20 or the fluctuations in sunshine strength, or to suppress the unnecessary erroneous reports when the three-dimensional object 22 is left.

### Embodiment 2

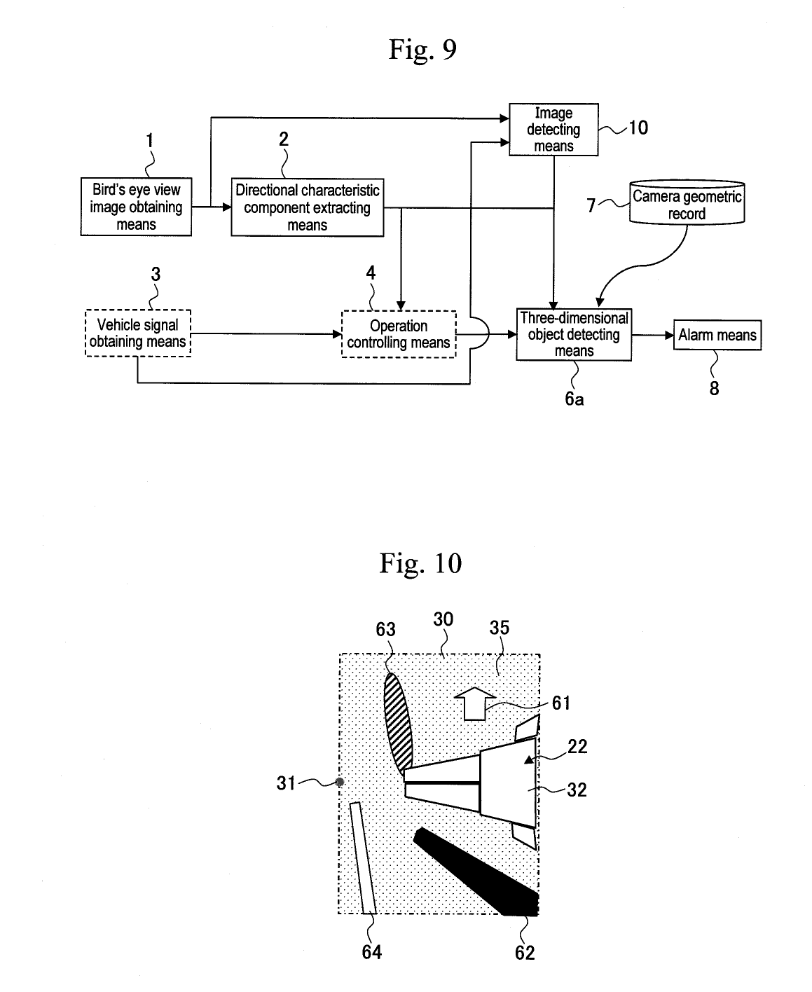

FIG. 9 shows a functional block diagram of Embodiment 2 of the present invention. It is to be noted that the identical numerical symbols are attached to the same constitutional elements as those of Embodiment 1, thereby omitting detailed explanations thereof.

In FIG. 9, an image detecting means 10 is a means that, by means of image processing, detects image changes or image features due to the three-dimensional object 22 around the vehicle 20. The image detecting means 10 may adopt a method for taking, as input, images in time series in which the images per processing cycle are stored in a buffer, in addition to a method for taking the image at the present time as input.

The image changes of the three-dimensional object 22 captured by the image detecting means 10 may be attached with prerequisites. For example, the image detecting means 10 may adopt a method for capturing the whole movement of the three-dimensional object 22 or motions of a limb under the prerequisite that the three-dimensional object 22 is movable.

The image features of the three-dimensional object 22 captured by the image detecting means 10 may also be attached with prerequisites. The image detecting means 10 may adopt a method for detecting a skin color under the prerequisite that a skin is exposed. Examples of the image detecting means 10 include a moving vector method for detecting a moving object based on a movement amount, in which corresponding points between images at two times are searched and obtained in order to capture motions of a whole or part of the three-dimensional object 22, or a skin color detection method for extracting skin color components from a color space of a color image in order to extract a skin color part of the three-dimensional object 22. However, the image detecting means 10 is by no means limited to these examples. Taking the image at the present time or those in time series as input, when detection requirements are satisfied in a local unit on the image, the image detecting means 10 outputs “detection ON;” whereas when the detection requirements are satisfied, the image detecting means 10 outputs “detection OFF”.

In FIG. 9, the operation controlling means 4 determines conditions, for which the image detecting means 10 operates, based on a signal of the vehicle signal obtaining means 3, and transmits the signal of the determination of detection to a three-dimensional object detecting means 6a under the conditions that the image detecting means 10 operates. The conditions for which the image detecting means 10 operates include, for example, a period of time in which the vehicle 20 is stopped when the image detecting means 10 adopts the moving vector method, which can be obtained from the vehicle speed or a parking signal. It is to be noted that in the case where the image detecting means 10 operates at all times through traveling of the vehicle 20, it is possible to omit the vehicle signal obtaining means 3 and the operation controlling means 4 in FIG. 9. At this time, the three-dimensional object detecting means 6a operates as if having received the signal of the determination of detection at all times.

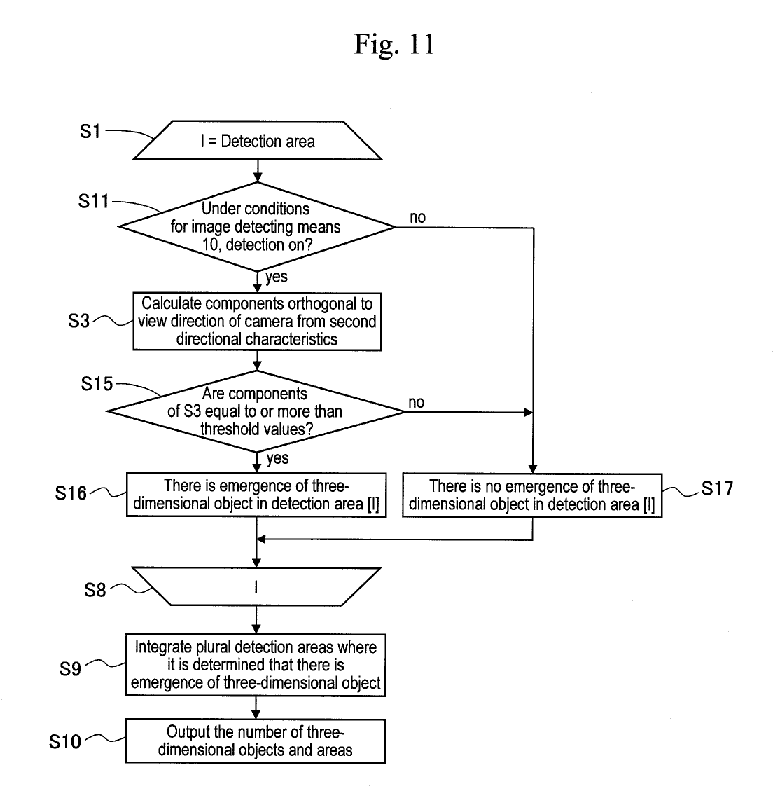

In FIG. 9, when receiving the signal of the determination of detection, the three-dimensional object detecting means 6a detects the three-dimensional object 22 in the flow of FIG. 11. In FIG. 11, the loop processing from Step S1 to Step S8 is the loop processing of the detection area [I] identical to that of Embodiment 1, shown in FIG. 5. As shown in the flow of FIG. 11, while changing the detection areas [I] in the loop processing from Step S1 to Step S8, when the image detecting means 10 outputs “detection OFF” in Step S11, it is determined that there is no three-dimensional object in the detection area [I] (Step S7). When the determination of Step S11 is “detection ON,” calculated are amounts of the orthogonal-direction characteristic components each having the direction nearly orthogonal to the view direction from the viewpoint 31 of the camera 21 (Step S3), among the directional characteristic components of the bird's-eye view image 30 at the present time.

It is determined whether or not the amounts of the orthogonal-direction characteristic components each having the direction nearly orthogonal to the view direction from the viewpoint 31 of the camera 21 obtained in Step S3, namely, a sum of S_{b+} obtained by the above-mentioned Formula 3 and S_{b-} obtained by the above-mentioned Formula 4 is equal to or more than a predetermined threshold value (Step S14). When the aforementioned amount or sum is equal to or more than the threshold value, it is determined that there is the three-dimensional object in the detection area [I] (Step S16). When such amount or sum is less than the threshold value, it is determined that there is no three-dimensional object in the detection area [I] (Step S17).

In subsequent Step S9, similarly to Embodiment 1, the plural detection areas are integrated. In Step S10, the number of the three-dimensional objects 22 and area information are output. Note that in the determination of Step S14, it is possible to use any method, in which two directions orthogonal to the view direction from the viewpoint 31 of the camera 21 (e.g., the direction 36 and the direction 37 in FIG. 7) are comprehensively evaluated, like a method using the maximum values of the orthogonal-direction characteristic components S_{b+} and S_{b-} each having the direction nearly orthogonal to the view direction from the viewpoint 31 of the camera 21, in place of the method in which the sum of the orthogonal-direction characteristic components S_{b+} and S_{b-}, each having the direction nearly orthogonal to the view direction from the viewpoint 31 of the camera 21, is compared with the predetermined threshold value. In Step S9, similarly to Embodiment 1, the plural detection areas are integrated. In Step S10, the number of the three-dimensional objects 22 and the area information are output.

FIG. 10 is one example of the bird's-eye view image 30, and therein, photographed are the three-dimensional object 22, a shadow 63 of the three-dimensional object 22, a strut 62, and a white line 64. The white line 64 extends in a radiation direction from the viewpoint 31 of the camera 21. The three-dimensional object 22 and the shadow 63 of the three-dimensional object 22 walk toward an upper direction 61 on the bird's-eye view image 30. An explanation will be made as to the flow of FIG. 11 when the case, in which the image detecting means 10 adopts the moving vector method, is taken for example and a situation of FIG. 10 is taken as input.

In FIG. 10, regarding portions of the three-dimensional object 22 and the shadow 63 of the three-dimensional object 22 on the bird's-eye view image 30, the moving vector method is in a state of “detection ON” due the movement to the upper direction 61. Thus, when the detection area [I] includes the three-dimensional object 22 and the shadow 63 of the three-dimensional object 22, the determination of Step S11 is “yes.” In the determination of Step S16 after the determination of Step S11 has been “yes”, the contour of the three-dimensional object 22 extends along the view direction from the viewpoint 31 of the camera 21 in the detection area [I] including the three-dimensional object 22. Thus, the directional characteristic components are focused on the components that intersect with the view direction from the viewpoint 31 of the camera 21, and the determination is “yes.”

Meanwhile, in the determination of Step S16, the shadow 63 of the three-dimensional object 22 does not extend along the view direction from the viewpoint 31 of the camera 21, so that the determination is “no.” Thus, it is only the three-dimensional object 22 that is detected in Step S10 in a scene of FIG. 10.

It is to be noted that supposing that a situation, in which the strut 62 extending along the view direction from the viewpoint 31 of the camera 21 or the white line 64 is determined in Step S15, is taken into consideration, the orthogonal-direction characteristic components each having the direction nearly orthogonal to the view direction from the viewpoint 31 of the camera 21 are concentrated and increased in the strut 62 or the white line 64, so that the determination result in Step S15 is “yes.” However, in the strut 62 or the white line 64, there is no movement amount, and the determination in Step S11 in a former stage than Step S15 is “no.” Thus, it is determined that there is no three-dimensional object in the detection area [I] including the strut 62 or the white line 64 (S17).

Under situations other than that of FIG. 10, assuming, for example, a scene where plants, which are the three-dimensional objects, sway in the wind around the vehicle 20, when the detection area [I] includes the plants, the scene is in the state of “detection ON” due to the movement of the plants between the images at the two times in the moving vector method (“yes” in Step S11).

However, if the plants are not tall and do not extend along the view direction from the viewpoint 31 of the camera 21, the determination of Step S16 is “no,” and it is determined that there is no three-dimensional object (Step S17). In addition, even in the case of a target to which the image detecting means 10 incidentally outputs “detection ON,” as long as the target incidentally in the state of “detection ON” does not extend along the view direction from the viewpoint 31 of the camera 21, such target is not detected as the three-dimensional object 22.

It is to be noted that in terms of the properties of the processing of the image detecting means 10, in the case where the three-dimensional object 22 can be only partially detected in the bird's-eye view image 30, in the flow of FIG. 11, determination conditions of Step S11 may be loosened in such a manner that the image detecting means 10 outputs “detection ON” in the detection area [I] or the detection area in the neighborhood of the detection area [I]. Additionally, in terms of the properties of the processing of the image detecting means 10, in the case where the image detecting means 10 can only intermittently detect the three-dimensional object 22 when viewed in time series, in the flow of FIG. 11, the determination conditions of Step S11 may be loosened in such a manner that the image detecting means 10 outputs “detection ON” prior to the present time or a predetermined processing cycle in the detection area [I].

Moreover, as in a situation where the three-dimensional object 22 moves, and thereafter, stops on the bird's-eye view image 30, in the case where the image detecting means 10 once outputs “detection ON;” but thereafter, the image detecting means 10 outputs “detection OFF,” resulting in losing sight of the three-dimensional object 22, in the flow of FIG. 11, the determination conditions of Step S11 may be loosened in such a manner that the image detecting means 10 outputs “detection ON” prior to the present time, or prior to a predetermined timeout time from the present time in the detection area [I].

In the above-mentioned example, the image detecting means 10 adopted the moving vector method. However, in a similar manner, also in other image processing methods, when the image detecting means 10 outputs “detection ON,” as long as the target in the state of “detection ON” does not extend along the view direction from the viewpoint 31 of the camera 21, it is possible to suppress the erroneous detection of those other than the three-dimensional object 22. Additionally, also after the image detecting means 10 has lost sight of the detected target, during the predetermined timeout time, when the target in the state of “detection ON” extends along the view direction from the viewpoint 31 of the camera 21, such target remains detected as the three-dimensional object 22.

In Embodiment 2 of the present invention, through the above-described functional configurations, among targets on which the image detecting means 10 by means of the image processing has performed the detection, those extending along the view direction from the viewpoint 31 of the camera 21 are selected, thereby enabling to eliminate the unnecessary erroneous reports when the image detecting means 10 detects those other than the three-dimensional object 22, such as the incidental disturbance.

Additionally, in Embodiment 2 of the present invention, also in the case where the image detecting means 10 detects the unnecessary area around the three-dimensional object 22, such as the shadow 63 of the three-dimensional object 22, it is possible to delete the unnecessary part other than the three-dimensional object 22 in the screen of the alarm means 8 and perform the output. Moreover, in Embodiment 2, also after the image processing means 10 has lost sight of the detected target, during the timeout time, as long as the target in the state of “detection ON” extends along the view direction from the viewpoint 31 of the camera 21, it is possible to continue the detection.

### Embodiment 3

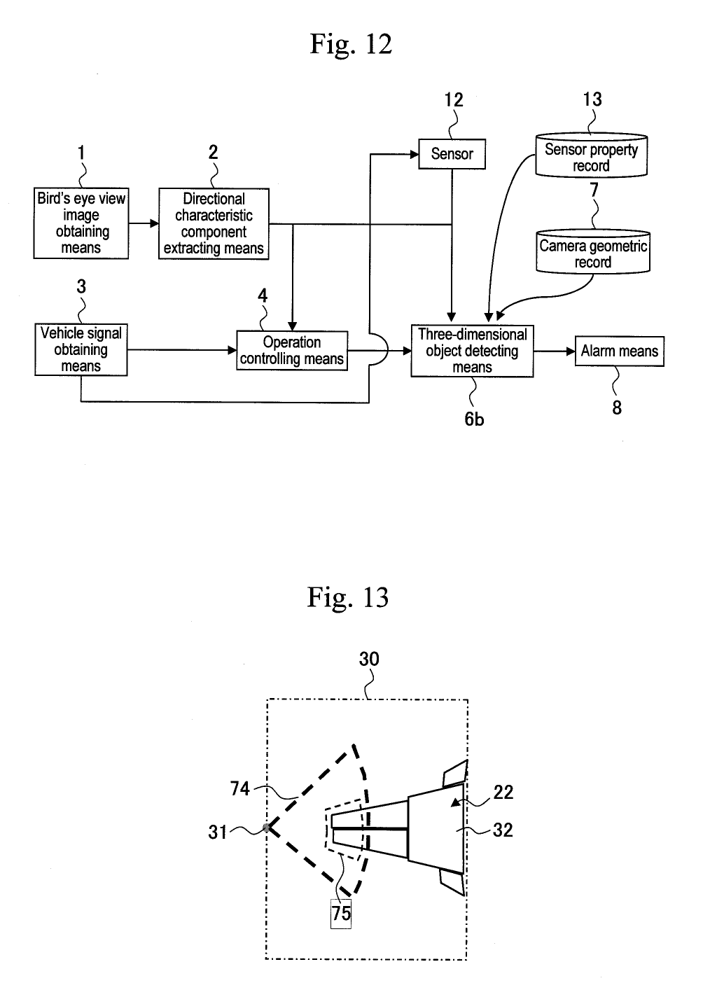

FIG. 12 shows a functional block diagram of Embodiment 3 of the present invention. It is to be noted that the identical numerical symbols are attached to the same constitutional elements as those of Embodiments 1 and 2, thereby omitting detailed explanations thereof.

In FIG. 12, a sensor 12 is a sensor that detects the three-dimensional object 22 around the vehicle 20. The sensor 12 determines the presence of the three-dimensional object 22 at least in a detection range, and outputs “detection ON” when the three-dimensional object 22 is present; whereas the sensor 12 outputs “detection OFF” when the three-dimensional object 22 is not present. Examples of the sensor 12 include an ultrasonic sensor, a laser sensor, or a millimeter wave radar; however, the sensor 12 is by no means limited thereto. It is to be noted that taking, as input, the image of the camera 21 that captures the surroundings of the vehicle with an angle of view other than that of the bird's-eye view image obtaining means 1, a combination of the camera 21, which detects the three-dimensional object 22, and the image processing is also included in the sensor 12.

In FIG. 12, the operation controlling means 4 determines conditions for which the sensor 12 operates based on the signal of the vehicle signal obtaining means 3, and transmits the signal of the determination of detection to a three-dimensional object detecting means 6b under the conditions in which the image detecting means 10 operates. The conditions for which the image detecting means 10 operates include, for example, a situation that the sensor 12 is the ultrasonic sensor which detects the three-dimensional object 22 on the rear of the vehicle 20 when such vehicle is backwardly moved, and transmits the signal of the determination of detection to the three-dimensional object detecting means 6b if the gear of the vehicle 20 is in a state of a back gear. It is to be noted that in the case where the sensor 12 operates through the traveling of the vehicle 20 at all times, it is possible to omit the vehicle signal obtaining means 3 and the operation controlling means 4 in FIG. 12. At this time, the three-dimensional object detecting means 6b operates as if having received the signal of the determination of detection at all times.

In FIG. 12, a sensor property record 13 records at least the detection range of the sensor 12 on the bird's-eye view image 30, preliminarily calculated based on the properties such as the positions in the space or a directional relationship of the camera 21, which inputs the image in the bird's-eye view image obtaining means 1, and the sensor 12; a measurement range of the sensor 12; and the like. Additionally, in the case where the sensor 12 outputs measurement information such as the distance or an orientation of the detected three-dimensional object 22, in addition to the determination as to the presence of the three-dimensional object 22, the sensor property record 13 records preliminarily calculated correspondences of the measurement information, such as the distance or the orientation of the sensor 12, and the areas on the bird's-eye view image 30.

FIG. 13 is one example of the bird's-eye view image 30, in which numerical 74 denotes the detection range of the sensor 12. In FIG. 13, the three-dimensional object 22 is included in the detection range 74, however, is by no means limited to this example. The three-dimensional object 22 may be outside of the detection range 74. In FIG. 13, a detection range 75 is an area on the bird's-eye view image 30, in which the measurement information such as the distance or the orientation of the sensor 12 has been converted with reference to the sensor property record 13, in the case where the sensor 12 outputs the measurement information such as the distance or the orientation other than “detection ON” and “detection OFF.”

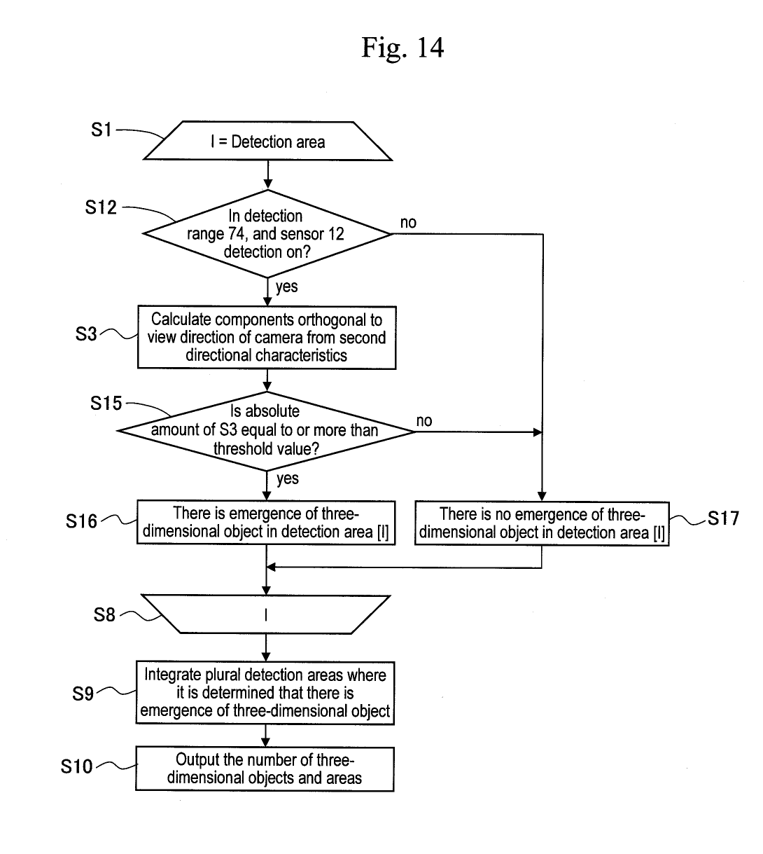

In FIG. 12, when receiving the signal of the determination of detection, the three-dimensional object detecting means 6b detects the three-dimensional object 22 in the flow of FIG. 14. In FIG. 14, the loop processing from Step S1 to Step S8 is the loop processing of the detection area [I] identical to that of Embodiment 1 shown in FIG. 5. In the flow of FIG. 14, while changing the detection areas [I] in the loop processing from Step S1 to Step S8, when the detection area [I] is overlapped with the detection area 74 of the sensor 12 and the sensor 12 satisfies the conditions for “detection ON” in Step S12, the flow moves to Step S3. However, the sensor 12 does not satisfy such conditions, it is determined that there is no three-dimensional object in the detection area [I] (Step S17).

Step S3 and Step S15 when the determination of Step S12 is “yes” are identical to those of Embodiment 2. In Step S3, the orthogonal-direction characteristic components, each having the direction nearly orthogonal to the view direction from the viewpoint 31 of the camera 21, are calculated from the directional characteristics of the bird's-eye view image 30 at the present time. Thereafter, in Step S15, the orthogonal-direction characteristic components obtained in Step S3, each having the direction nearly orthogonal to the view direction from the viewpoint 31 of the camera 21, have the values equal to or more than the threshold values, it is determined that there is the three-dimensional object in the detection area [I] (Step S16). When such values are less than the threshold value, it is determined that there is no three-dimensional object in the detection area [I] (Step S17).

In terms of the properties of the sensor 12, in the case where the detection range 74 of the sensor 12 covers only the limited area on the bird's-eye view image 30, even if the three-dimensional object 22 is present on the bird's-eye view image 30, merely a part of the three-dimensional object 22, which extends along the view direction from the viewpoint 31 of the camera 21, can be detected.

For example, in the case of FIG. 13, the detection range 74 of the sensor 12 captures only a foot 75 of the three-dimensional object 22. Thus, in the case where the detection range 74 of the sensor 12 covers only the limited area on the bird's-eye view image 30, in the determination of Step S12 of FIG. 14, the determination conditions in Step S12 may be loosened in such a manner that the detection area [I] or some detection area along the distance p of the polar coordinates from the detection area [I] is overlapped with the detection range 74 of the sensor 12.

For example, given that the detection area of (p1, p2, q2, q1) in the coordinate partitioning 40 of FIG. 6 is overlapped with the detection range 74 of the sensor 12, even if the detection area of (p2, p3, q3, q2) is not overlapped with the detection range 74, it is considered that the detection area of (p2, p3, q3, q2) has overlapping with the detection area [I] in the determination of Step S12.

In terms of the properties of the sensor 12, in the case where the sensor 12 can only intermittently detect the three-dimensional object 22 when viewed in time series, in the determination of Step S12 of FIG. 14, the determination conditions of Step S12 may be loosened in such a manner that the sensor 12 outputs “detection ON” prior to the present time or a predetermined processing cycle in the detection area [I].

Moreover, in the case where the sensor 12 once outputs “detection ON;” but thereafter, outputs “detection OFF,” resulting in losing sight of the three-dimensional object 22, in the flow of FIG. 14, the determination conditions of Step S12 may be loosened in such a manner that the image detecting means 10 outputs “detection ON” prior to the present time, or prior to a predetermined timeout time from the present time in the detection area [I].

In the case where the sensor 12 outputs the measurement information such as the distance or the orientation other than “detection ON” and “detection OFF,” taking the detection range 75 as an effective area of the detection range 74, the detection area [I] is in the detection range 74 in Step S12, so that the conditions, for which the detection area [I] is in the detection range 75, may be tightened. In this way, in Step S12, when comparing the detection area [I] with the detection range 75, even if the strut 62 or the white line 64, as in FIG. 10, other than the three-dimensional object 22 is included in the detection range 74, it is possible to suppress extra detection.

In Embodiment 3 of the present invention, through the above-described functional configurations, among targets detected by the sensor 12, those extending along the view direction from the viewpoint 31 of the camera 21 are selected, thereby enabling to suppress the detection of the targets other than the three-dimensional object 22 or the detection of the incidental disturbance, and thus, to decrease the erroneous reports. Additionally, also after the image processing has lost sight of the detected target, as long as the target in the state of “detection ON” extends along the view direction from the viewpoint 31 of the camera 21 during the timeout time, it is possible to continue the detection.

In the present Embodiment 3, through the above-described functional configurations, from the detection range 74 or the detection range 75 of the sensor 12, the detection range extending along the view direction from the viewpoint 31 of the camera 21 is selected, thereby enabling to decrease the unnecessary erroneous reports when the sensor 12 detects those other than the three-dimensional object, such as the incidental disturbance. Additionally, in the present Embodiment 3, even in the case where the sensor 12 detects the limited unnecessary area around the three-dimensional object on the bird's-eye view image 30, it is possible to delete the unnecessary part other than the three-dimensional object 22 in the screen of FIG. 8 and perform the output.

Moreover, in the present Embodiment 3, the determination conditions are loosened in such a manner that the overlapping of the detection area [I] with the detection range 74 is made somewhere along the polar coordinates of the coordinate grid 40, thereby enabling to detect an overall image of the three-dimensional object 22 even in the case where the detection range 74 of the area sensor 12 is narrow on the bird's-eye view image 30.

According to the present invention, the emergence of the three-dimensional object 22 is detected by comparing the amounts of the directional characteristic components of the images before and after the interval 50 when the driver's attention is deviated from the confirmation of the surroundings of the vehicle 20 (e.g., the bird's-eye view images 30a and 30b), so that it is possible to detect the three-dimensional object 22 around the vehicle 20 even in a situation where the vehicle 20 is stopped. Additionally, the emergence of the three-dimensional object 22 can be detected by the single camera 21. Moreover, it is possible to suppress the unnecessary alarm when the three-dimensional object 22 is left. Besides, through use of the orthogonal-direction characteristic components among the directional characteristic components, it is possible to suppress the erroneous reports due to the incidental changes in the image, such as the sway of the sunshine or the movement of the shadow.

It is to be noted that the present invention is by no means limited to the above-mentioned embodiments, and various modifications can be made within a range not departing from the spirit and scope of the present invention.

1. A three-dimensional object emergence detecting device configured to detect the emergence of a three-dimensional object in the vicinity of a vehicle based on a bird's-eye view image taken by a camera mounted in the vehicle, wherein
the three-dimensional object emergence detecting device extracts orthogonal-direction characteristic components, each of which is on the bird's-eye view image and has a direction nearly orthogonal to a view direction of the camera, from the bird's-eye view image, and detects the emergence of the three-dimensional object based on amounts of the extracted orthogonal-direction characteristic components.

2. A three-dimensional object the emergence detecting device configured to detect the emergence of a three-dimensional object in the vicinity of a vehicle based on a bird's-eye view image taken by a camera mounted in the vehicle, comprising:
a bird's-eye view image obtaining means for obtaining the plurality of bird's-eye view images taken by the camera at a predetermined time interval;
a directional characteristic component extracting means for extracting orthogonal-direction characteristic components, each of which is a directional characteristic component that is on the bird's-eye view image and has a direction nearly orthogonal to a view direction of the in-vehicle camera, from the bird's-eye view image obtained by the bird's-eye view image obtaining means; and
a three-dimensional object detecting means for comparing amounts of the orthogonal-direction characteristic components extracted by the directional characteristic component extracting means among the plurality of bird's-eye view images, and when increments of the orthogonal-direction characteristic components are equal to or more than preliminarily set threshold values, it is determined that there is the emergence of the three-dimensional object.

3. A three-dimensional object emergence detecting device configured to detect the emergence of a three-dimensional object in the vicinity of a vehicle based on a bird's-eye view image taken by a camera mounted in the vehicle, comprising:
a vehicle signal obtaining means for obtaining a signal from at least one of a control device of the vehicle and an information device mounted in the vehicle;
an operation controlling means for, based on the signal from the vehicle signal obtaining means, recognizing a start point and an end point of an interval when attention of a driver of the vehicle is deviated from confirmation of surroundings of the vehicle;
a bird's-eye view image obtaining means for, based on information from the operation controlling means, obtaining the plurality of bird's-eye view images taken by the camera at a predetermined time interval;
a directional characteristic component extracting means for extracting orthogonal-direction characteristic components, each of which is a directional characteristic component that is on the bird's-eye view image and has a direction nearly orthogonal to a view direction of the in-vehicle camera, from the bird's-eye view image obtained by the bird's-eye view image obtaining means; and
a three-dimensional object detecting means for comparing amounts of the orthogonal-direction characteristic components extracted by the directional characteristic component extracting means among the plurality of bird's-eye view images, and when increments of the orthogonal-direction characteristic components are equal to or more than preliminarily set threshold values, it is determined that there is the emergence of the three-dimensional object.

4. A three-dimensional object emergence detecting device configured to detect the emergence of a three-dimensional object in the vicinity of a vehicle based on a bird's-eye view image taken by a camera mounted in the vehicle, comprising:
a bird's-eye view image obtaining means for obtaining the bird's-eye view image;
an image detecting means for detecting image changes or image features due to the three-dimensional object by performing image processing on the bird's-eye view image obtained by the bird's-eye view image obtaining means;
a directional characteristic component extracting means for, when the image changes or the image features detected by the image detecting means satisfy preliminarily set conditions, extracting orthogonal-direction characteristic components, each of which is a directional characteristic component that is on the bird's-eye view image and has a direction nearly orthogonal to a view direction of the in-vehicle camera, from the bird's-eye view image obtained by the bird's-eye view image obtaining means; and
a three-dimensional object detecting means for detecting the emergence of the three-dimensional object based on amounts of the orthogonal-direction characteristic components extracted by the directional characteristic component extracting means.

5. The three-dimensional object emergence detecting device according to claim 4, wherein also when losing sight of the detected three-dimensional object, the image detecting means continues detection of the three-dimensional object by means of the three-dimensional object detecting means.

6. A three-dimensional object emergence detecting device configured to detect the emergence of a three-dimensional object in the vicinity of a vehicle based on a bird's-eye view image taken by a camera mounted in the vehicle, comprising:
a bird's-eye view image obtaining means for obtaining the bird's-eye view image;
a sensor for detecting the three-dimensional object present around the vehicle;
a directional characteristic component extracting means for, when the sensor detects the three-dimensional object, extracting orthogonal-direction characteristic components, each of which is a directional characteristic component that is on the bird's-eye view image and has a direction nearly orthogonal to a view direction of the in-vehicle camera, from the bird's-eye view image obtained by the bird's-eye view image obtaining means; and
a three-dimensional object detecting means for detecting the emergence of the three-dimensional object based on amounts of the orthogonal-direction characteristic components extracted by the directional characteristic component extracting means.

7. The three-dimensional object emergence detecting device according to claim 2, comprising an alarm means for issuing an alarm when the three-dimensional object detecting means determines that there is the emergence of the three-dimensional object.

8. The three-dimensional object emergence detecting device according to claim 7, wherein the alarm means displays, on a screen, the bird's-eye view image and a frame line showing a silhouette of the three-dimensional object.

9. The three-dimensional object emergence detecting device according to claim 8, wherein the alarm means changes a size of the frame line depending on a distance between the camera and the three-dimensional object.

10. The three-dimensional object emergence detecting device according to claim 7, wherein the alarm means converts the bird's-eye view image obtained by the bird's-eye view image obtaining means into a bird's-eye view image having a narrower angle of view, and displays the converted bird's-eye view image on the screen.

11. The three-dimensional object emergence detecting device according to claim 3, comprising an alarm means for issuing an alarm when the three-dimensional object detecting means determines that there is the emergence of the three-dimensional object.

12. The three-dimensional object emergence detecting device according to claim 4, comprising an alarm means for issuing an alarm when the three-dimensional object detecting means determines that there is the emergence of the three-dimensional object.

13. The three-dimensional object emergence detecting device according to claim 5, comprising an alarm means for issuing an alarm when the three-dimensional object detecting means determines that there is the emergence of the three-dimensional object.

14. The three-dimensional object emergence detecting device according to claim 8, wherein the alarm means converts the bird's-eye view image obtained by the bird's-eye view image obtaining means into a bird's-eye view image having a narrower angle of view, and displays the converted bird's-eye view image on the screen.

15. The three-dimensional object emergence detecting device according to claim 9, wherein the alarm means converts the bird's-eye view image obtained by the bird's-eye view image obtaining means into a bird's-eye view image having a narrower angle of view, and displays the converted bird's-eye view image on the screen.
